(19) United States
(12) Patent Application Publication
(10) Pub. No.: US 2008/0300781 A1
(43) Pub. Date: Dec. 4, 2008

(54) Route setting system, route setting method, and program for executing the method

(75) Inventor: Takamitsu Sakai, Okazaki-shi (JP)

Correspondence Address: BACON & THOMAS, PLLC, 625 SLATERS LANE, FOURTH FLOOR, ALEXANDRIA, VA, 22314-1176, US

(73) Assignee: AISIN AW CO., LTD., Anjo-shi (JP)

(21) Appl. No.: 12/153,729

(22) Filed: May 23, 2008

(30) Foreign Application Priority Data
May 31, 2007 (JP) 2007-144754

(51) Int. Cl. G01C 21/36

(52) U.S. Cl. 701/202

(57) ABSTRACT

The present invention enables accurate setting of a road as a driving route by reading the scale of a map displayed on a map screen, reading matching target roads correlated with the scale of the map. The matching target roads are used for setting a driving route. A determination is made whether or not a road has been specified by an operator and, if a locus of road has been specified by the operator, one of the matching target roads nearest to the specified locus is used for setting the driving route.

### INCORPORATION BY REFERENCE

The disclosure of Japanese Patent Application No. 2007-144754 filed on May 31, 2007, including the specification, drawings and abstract thereof, is incorporated herein by reference in its entirety.

### BACKGROUND OF THE INVENTION

1. Field of the Invention

The present invention relates to a route setting system, a route setting method, and a program for executing the method.

2. Description of the Related Art

Conventionally, in a navigation device, when a driver inputs the destination and sets a search condition, a route search process is performed on the basis of the search condition to search for a route from the place of departure indicated by the current location to the destination on the basis of map data. Then, the route found by the search, i.e., the selected route, is displayed on a map screen formed on a display unit together with a vehicle symbol representing the current location of the vehicle, to thereby provide guidance along the selected route, i.e., the route guidance. Further, in addition to the display of the selected route (“driving route”) on the map screen, route guidance is also provided by audio output.

Accordingly, the driver can drive the vehicle along the displayed selected route.

Another conventional navigation device displays a route to the destination on a map screen of a display unit with a touch panel. The displayed route is set as the driving route to the destination by tracing with a finger along roads on the displayed map, without execution of a search for a route (see Japanese Unexamined Patent Application Publication No. 2000-111354, for example).

### SUMMARY OF THE INVENTION

In the above-described navigation apparatus of JP2000-111354, however, if a plurality of roads are located adjacent one another, for example, a road different from the road intended by the driver may be set as the driving route.

FIG. 2 and FIG. 3 are diagrams illustrating a conventional method for setting a driving route.

In FIGS. 2 and 3, r1 and r11, Rt1 and Rt2, s1, and e1 indicate roads, driving routes, the starting point of the tracing, and the ending point of the tracing, respectively. The road r11 branches from the road r1 at a branch point p1.

On the map screen of FIG. 2, if the driver's finger fails to accurately touch the road r1 on the touch panel as the driver traces with his finger along the road r1, from the tracing start point s1 to the tracing end point e1, to set the road r1 as the driving route Rt1, in addition to a portion of the road r1, a portion of the road r11 may be erroneously set as the driving route R2, as illustrated in FIG. 3, for example.

In view of the above-described problem of the conventional navigation device, it is an object of the present invention to provide a route setting system, a route setting method, and a program for executing the method capable of accurately setting a selected road as the driving route.

To achieve the foregoing object, the present invention provides a route setting system which includes scale determination means for reading the scale of a map displayed on a map screen, matching target road selection means for selecting, in accordance with the scale of the map, matching target roads which are target roads used for setting a driving route, specification determination means for determining whether or not a road has been specified by an operator, and road selection means for selecting, responsive to a road having been specified by the operator, one of the matching target roads nearest a specified point, as a road set for the driving route.

According to the present invention, if a road has been specified by the operator, one of the matching target roads nearest to the specified point is selected as the road used for setting the driving route. Therefore, the intended road can be accurately set as the driving route.

### BRIEF DESCRIPTION OF THE DRAWINGS

FIG. 1 is a block diagram of an embodiment of a navigation system in accordance with the present invention;

FIG. 2 is a first diagram illustrating a conventional driving route setting method;

FIG. 3 is a second diagram illustrating the conventional driving route setting method;

FIG. 4 is a flowchart of a driving route setting method of an embodiment of the present invention;

FIG. 5 is a table of examples of map scale and road categories in the present invention;

FIG. 6 is a map diagram explaining the driving route setting method of an embodiment of the present invention; and

FIG. 7 is a table of examples of map scale and matching road categories in an embodiment of the present invention.

### DESCRIPTION OF THE PREFERRED EMBODIMENTS

An embodiment of a navigation system serving as a route setting system of the present invention will now be described in detail below with reference to the drawings.

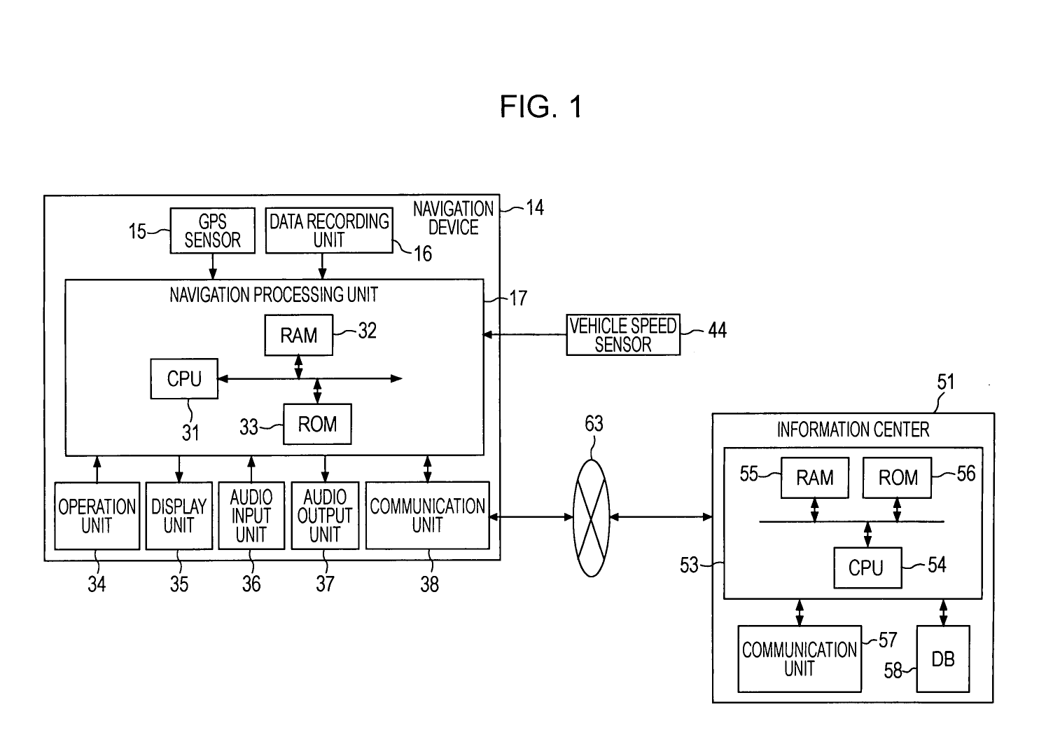

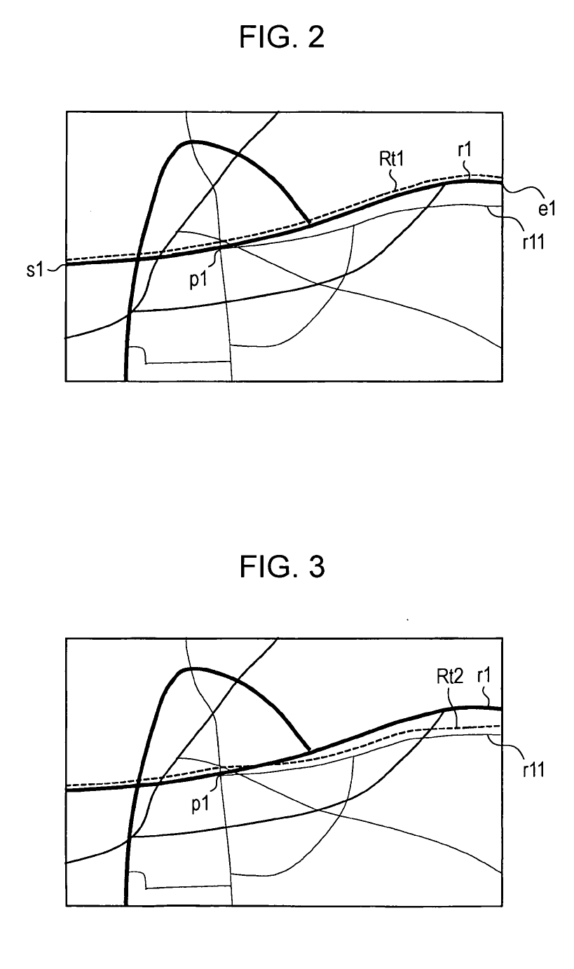

In FIG. 1A, reference numerals 14, 63, and 51 respectively indicate an information terminal such as a navigation apparatus serving as an on-board device installed in a vehicle, a network, and an information center serving as an information provider. The navigation apparatus 14, the network 63, and the information center 51, together constitute a navigation system.

The navigation apparatus 14 includes a GPS (Global Positioning System) sensor 15, a data recording unit 16, a navigation processing unit 17, an operation unit 34, a display unit 35, an audio input unit 36, an audio output unit 37, and a communication unit 38. The GPS sensor 15 serves as a current location detection unit for detecting the current location of the vehicle as a vehicle location and the direction of the vehicle as a vehicle direction. The data recording unit 16 serves as an information recording unit in which map data and a variety of other information are recorded. The navigation processing unit 17 performs a variety of arithmetic processes including navigation processing. The operation unit 34 serves as a first input unit used for input through operation of the unit by a driver, i.e., an operator. The display unit 35 serves as a first output unit for providing a variety of displays in the form of images displayed on a screen for viewing by the driver. The audio input unit 36 serves as a second input unit used for voice input by the driver. The audio output unit 37 serves as a second output unit for audio output of a variety of information to the driver. The communication unit 38 (terminal) serves to transmit and receive information. The navigation processing unit 17 is connected to the GPS sensor 15, the data recording unit 16, the operation unit 34, the display unit 35, the audio input unit 36, the audio output unit 37, and the communication unit 38. The navigation processing unit 17 is further connected to a vehicle speed sensor 44 for detecting the vehicle speed. The GPS sensor 15 detects the time as well as the vehicle location and the vehicle direction. The vehicle direction can also be detected by a direction sensor provided independently of the GPS sensor 15.

The data recording unit 16 includes a map database formed of map data files in which the map data is recorded. The map data includes intersection data relating to intersections (branch points), node data relating to nodes, road data relating to road links, search data which is processed in route searching, and facility data relating to facilities. The map data further includes feature data relating to features on roads.

The data recording unit 16 further includes databases such as a statistical database with statistical data files and a driving history database with driving history data files. Statistical data and driving history data are recorded in the statistical data files and the driving history data files, respectively.

The data recording unit 16 records the variety of data described above on a disk, such as a hard drive, a CD (Compact Disk), a DVD (Digital Versatile Disk), or an optical disk. The data recording unit 16 further includes a head for reading and writing a variety of data, i.e. a read-write head. The data recording unit 16 can also include a memory card or the like. The disks, the memory card, and so forth constitute an external storage device.

Alternatively, the databases such as the map database, the statistical database, and the driving history database, which are formed in the data recording unit 16 in the present embodiment, can be provided in the information center 51.

The navigation processing unit 17 includes a CPU (Central Processing Unit) 31, a RAM (Random Access Memory) 32, a ROM (Read-Only Memory) 33, a flash memory, and so forth. The CPU 31 serves as a control unit for controlling the entirety of the navigation device 14 and also as an arithmetic processing unit. The RAM 32 is used as a working memory in a variety of arithmetic processes executed by the CPU 31. The ROM 33 stores a control program and a variety of other programs for performing operations such as searching for a route to the destination and route guidance. The flash memory is used to record a variety of data and programs. The RAM 32, the ROM 33, the flash memory, and so forth constitute an internal storage device.

A keyboard, a mouse, etc., can be used as the operation unit 34. Further, a touch panel is used as the display unit 35. A variety of screens formed on the display unit 35 are employed to display the vehicle location, the vehicle direction, a map, a driving route (“selected route”), guidance information for guidance along the driving route, traffic information, the distance to the next intersection on the driving route, the direction of travel at the next intersection, and so forth. Further, the display unit 35 also functions as an operation unit. Thus, an input operation can be performed by touching an image operation symbol displayed on one of the screens in the form of an image, which symbol may be one or more of a variety of keys, switches, buttons, and so forth.

Further, the audio input unit 36 includes a microphone and accessory components necessary for input of information by voice or other sound. The audio output unit 37 includes a sound synthesis device and a speaker for providing audible route guidance along the driving route.

The communication unit 38 includes receivers such as a beacon receiver and a FM (Frequency Modulation) receiver. The beacon receiver receives a variety of information such as current traffic information transmitted from a road traffic information center and general information. The FM receiver receives information in the form of FM multiplex broadcasting via a FM broadcast station. In addition to information such as traffic information and general information, the communication unit 38 can receive data such as the map data, the statistical data, and the driving history data from the information center 51 via the network 63.

Therefore, the information center 51 includes a server 53, a communication unit 57 connected to the server 53, a database (DB) 58 serving as an information recording unit, and so forth. The server 53 includes a CPU 54 serving as a control unit and as an arithmetic processing unit, a RAM 55, and a ROM 56. Further, data similar to the variety of data recorded in the data recording unit 16 is recorded in the database 58.

Each of the components such as the navigation system, the navigation processing unit 17, the CPU 31, the CPU 54, and the server 53 functions as a computer when operating independently or in combination with at least another one of the components, and performs arithmetic processing on the basis of a variety of programs and data. Further, the data recording unit 16, the RAM 32, the RAM 55, the ROM 33, the ROM 56, the database 58, the flash memory are each a recording medium. Further, as the arithmetic processing unit, each of the CPU 31 and the CPU 54 can be replaced by an MPU (Micro Processing Unit) or the like.

Basic operation of the navigation system having the above-described configuration will now be described.

Firstly, upon activation of the navigation device 14 through the operation of the operation unit 34 by the driver, current location reading means (section) of the CPU 31 executes a current location reading process to read the vehicle location and the vehicle direction detected by the GPS sensor 15. Then, a matching processing means (section) of the CPU 31 executes a matching program to identify the vehicle location by identification of the road link on which the vehicle is located, utilizing information such as the track of the read vehicle location and the shape and the arrangement of each of the road links of the roads surrounding the vehicle location.

Subsequently, the CPU 31 acquires map data by reading the map data from the data recording unit 16 or by receiving the map data from the information center 51 via the communication unit 38. In the acquisition of the map data from the information center 51, the CPU 31 downloads the received map data into the flash memory.

Then, display processing means (section) 312 of the CPU 31 executes a display process to form one of a variety of screens on the display unit 35. For example, the display means 312 may execute a map display process to form a map screen on the display unit 35 to display a map showing a surrounding area and to display on the map screen the vehicle location and the vehicle direction.

Accordingly, the driver can drive the vehicle in accordance with the map, the vehicle location, and the vehicle direction.

Further, upon input of the destination through the operation of the operation unit 34 by the driver, a destination setting processing means (section) of the CPU 31 executes a destination setting routine to set the destination. The place of departure can also be input and set, as needed. It is also possible to pre-register certain locations and to set one of the registered locations as the destination. Subsequently, upon input of a search condition through the operation of the operation unit 34 by the driver, a search condition setting means (section) of the CPU 31 executes a search condition setting routine to set the search condition.

When the destination and the search condition have been thus set, route search means (section) 313 of the CPU 31 executes a route search routine to read the vehicle location, the vehicle direction, the destination, the search condition, and so forth, and to read the search data from the data recording unit 16. Then, on the basis of the vehicle location, the vehicle direction, the destination, the search data, and so forth, the route search means 313, in the automatic mode, searches for a route from the place of departure indicated by the vehicle location to the destination under the search condition, and outputs route data representing the selected route (“driving route”) determined by the search. In this process, the route having the smallest sum of link costs assigned to the respective road links of the route is selected as the driving route.

The route search process in the automatic mode can also be executed in the information center 51. In this case, the CPU 31 transmits the vehicle location, the vehicle direction, the destination, the search condition, and so forth to the information center 51 via the network 63. When the information center 51 receives the vehicle location, the vehicle direction, the destination, and the search condition, a route search processing section of the CPU 54 executes a route search routine similar to that executed by the CPU 31, to thereby read the search data from the database 58, to search for a route from the place of departure to the destination, within the confines of the search condition, on the basis of the vehicle location, the vehicle direction, the destination, and the search data, and to output route data representing the selected driving route. Then, a transmission processing means (section) of the CPU 54 executes a transmission routine to transmit the route data to the navigation device 14 via the network 63.

Subsequently, guidance processing means (section) 314 of the CPU 31 executes a guidance routine to provide route guidance. To provide the route guidance, the guidance processing means executes a route display routine to read the route data and to display the selected driving route on the map screen in accordance with the route data.

In the present embodiment, a touch panel is used as the display unit 35. Therefore, if an area or route is touched, i.e., traced in the present embodiment, along a road on the map screen, that road is specified and set as the driving route to the destination (touch mode), without execution of the route search process (automatic mode).

Through the operation by the driver of a mode selection switch 341 provided in the operation unit 34, operation may be switched between the automatic search mode in which the destination is input to search for a route and a touch mode in which a finger is used to trace along a road of the map display on the screen/touch panel, to set the driving route.

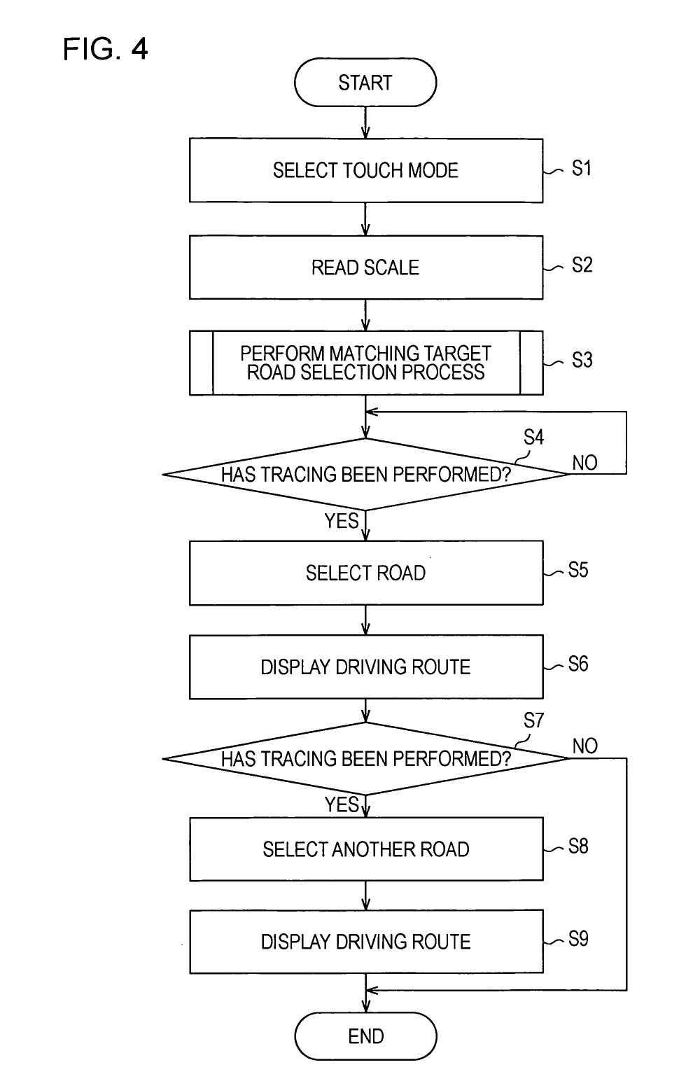

An embodiment of the method of setting the driving route in the touch mode will now be described with reference to FIGS. 4, 5, 6 and 7.

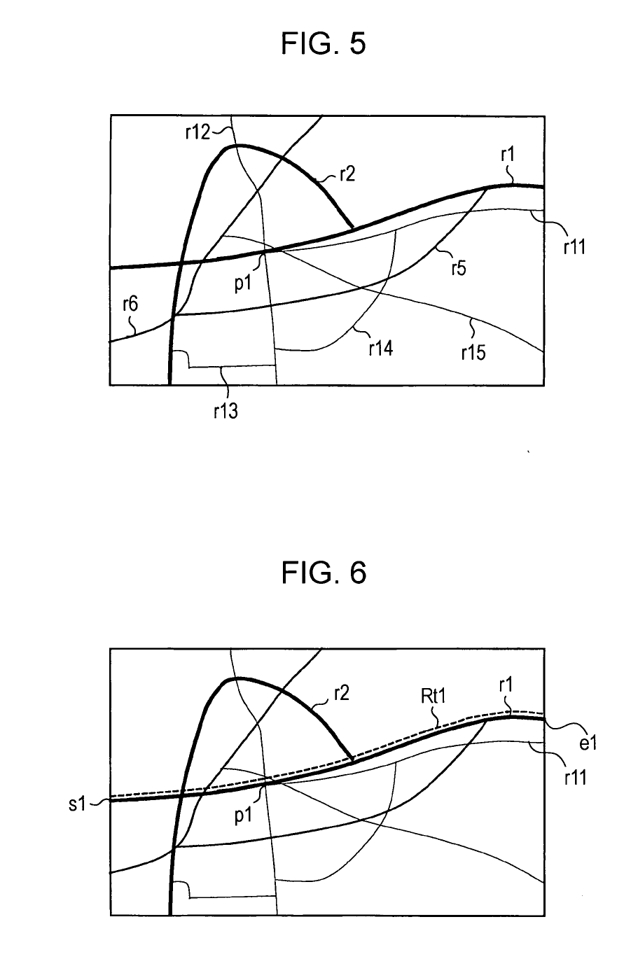

In FIG. 5, r1, r2, r5, r6, and r11 to r15 indicate roads, and p1 indicates a branch point at which the road r11 branches from the road r1.

Within the road data, as stored in the data recording unit 16, the respective roads are classified into types in accordance with the attributes of the roads (FIG. 1). That is, each road is classified as one of the first through tenth types. The first type includes intercity expressways. The second type includes the toll roads such as urban expressways. The third type includes the single-digit national highways. The fourth type includes the two-digit national highways. The fifth type includes the remainder of the national highways. The sixth type includes the major state (or prefectural or county) highways. The seventh type includes the remaining state highways. The eighth type includes the major local roads. The ninth type includes the remainder of the local roads. The tenth type includes the narrow streets. The respective roads, which are classified into the first to tenth types in accordance with their attributes, can also be classified in accordance with the average amount of traffic thereon or in accordance with the road distance from the starting point to the ending point.

Among the respective roads r1, r2, r5, r6, and r11 to r15 in the present embodiment, the roads r1 and r2 are single-digit national highways, and therefore belong to the third type. Further, the roads r5 and r6 are major state (or prefectural or county) highways and therefore are classified as the sixth type. Further, the roads r11 to r15 are the local roads of the ninth type.

Firstly, mode determination means (section) 311 of the CPU 31 executes a mode determination routine to determine whether or not the touch mode has been selected. If the touch mode has been selected, driving route setting means (section) 315 of the CPU 31 executes a driving route setting routine to set a road traced with a finger on the map screen as the driving route to the destination.

In a case in which a plurality of roads are located closely adjacent to one another where a finger traces along a road on the map screen to set the driving route to the destination, if all of the adjacent roads are set as target roads used for setting the driving route, i.e., matching target roads, a road different from the road intended by the driver may be set as the driving route.

In the present embodiment, therefore, the matching target roads are changed in accordance with the scale of the map displayed on the map screen.

Therefore, scale determination means (section) 316 of the driving route setting means 315 executes a scale determination routine to read the scale of the map displayed on the map screen at the time of execution. The map screen is formed thereon with a plurality of scale change switches for respective scales. The switches constitute a scale change unit for changing the scale of the displayed map. When the driver touches (specifies) one of the scale change switches, the scale of the map is changed. Accordingly, on the basis of output of a sensor associated with the operated scale change switch, the scale determination means 316 reads the scale of the map displayed on the map screen.

The scale of the map is expressed as the size of the area shown by the map on the map screen. The map is classified as one of, for example, a street map, a 50 m map, a 100 m map, a 200 m map, a 400 m map, an 800 m map, a 1.6 km map, a 3 km map, a 7 km map, a 13 km map, a 26 km map, a 50 km map, a 100 km map, etc., in order from the area of smallest size.

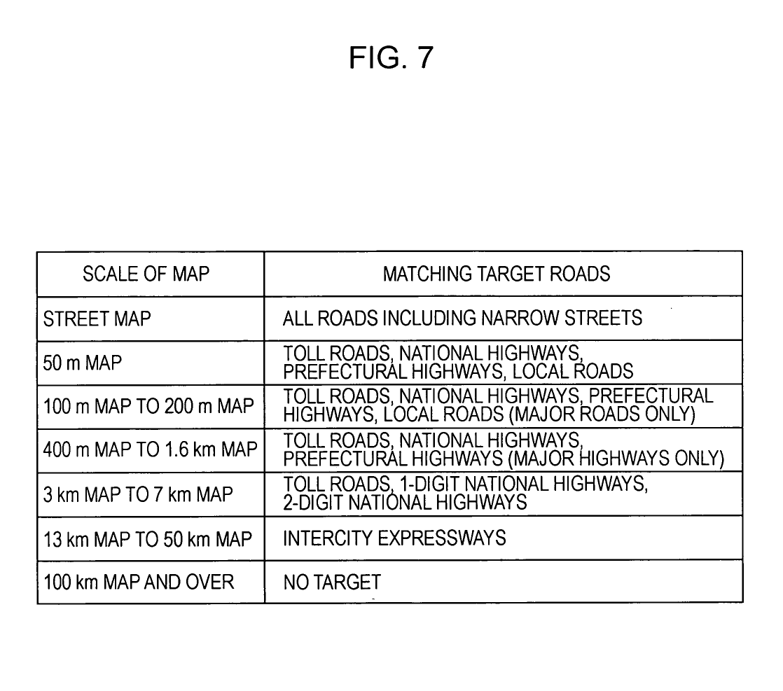

Subsequently, matching target road selection means (section) 317 of the driving route setting means 315 executes a matching target road selection routine to select the matching target roads corresponding to the scale of the map by referring to the matching target road table of FIG. 7 recorded in the data recording unit 16.

In the present embodiment, if the 100 km map is displayed on the map screen, there is no matching target road, and if the 13 km map, the 26 km map, or the 50 km map is displayed, the intercity expressways are included as matching target roads. Further, if the 3 km map or the 7 km map is displayed, the toll roads, the single-digit national highways, and the two-digit national highways are included in the matching target roads, and if the 400 m map, the 800 m map, or the 1.6 km map is displayed, the toll roads, the remainder of the national highways, and the major state (prefectural) highways are included in the matching target roads. Further, if the 100 m map or the 200 m map is displayed, the toll roads, the remainder of the national highways, the remainder of the state (prefectural) highways, and the major local roads are included in the matching target roads, and if the 50 m map is displayed, the toll roads, the remainder of the national highways, the remainder of the state (or prefectural or county) highways, and the remainder of the local roads are included in the matching target roads. Further, if the street map is displayed, all roads including the narrow streets are included in the matching target roads.

The roads not included in the matching target roads are excluded in setting the driving route.

Then, specification determination means (section) 318 of the driving route setting means 315 executes a specification determination routine to determine whether or not a road on the map screen has been specified by touch of a road on the map display by the driver, i.e., whether or not the driver's finger has traced a road on the map screen.

If the driver has traced a road on the map screen, road selection means (section) 319 of the driving route setting means 315 executes a road selection process to select, from the matching target roads corresponding to the read scale, i.e., the matching target roads corresponding to the map displayed on the map screen, the road nearest to a point touched by the driver, i.e., the road nearest to the track of tracing in the present embodiment, as the road used for setting the driving route.

In the present embodiment, the driver traces a road on the map screen. Alternatively, a point on a road may be specified by touch and the road nearest to the specified point selected as the road as the driving route. Further, when a plurality of points on a road are specified by touch, the road nearest to the track drawn by connecting the plurality of specified points may be selected as the road set as the driving route.

For example, if the map shown in FIG. 6 is the 3 km map, the toll roads, the single-digit national highways, and the two-digit national highways are included in the matching target roads. Thus, if the driver traces a road from the starting point s1 to the tracing end point e1, the road selection means selects, from among the single-digit national highways r1 and r2, the road r1 for setting the driving route. In this case, the road r11 is included among the remaining local roads, and thus is not included in the matching target roads in the 3 km map. Therefore, the road r11 is not a candidate road for setting the driving route.

When the road r1 used for setting the driving route has been thus selected, driving route display means of the driving route setting means executes a driving route display routine to display the driving route Rt1 on the map along the road r1.

Subsequently, when the driver touches a confirmation key on the map screen, route confirmation means of the driving route setting means executes a route confirmation routine to confirm the driving route Rt1 displayed on the map screen. Thus, the driving route is set in the above-described manner.

In the selection of the road used for setting the driving route, from among the matching target roads corresponding to scale of the map displayed on the map screen, if the selected road is not the road intended by the driver, and if the driver again traces the road from the tracing start point s1 to the tracing end point e1, the road selection means selects from among the matching target roads another road adjacent the already selected road as a candidate for the driving route Rt1, for example. Then, the driving route display means displays the driving route on the map along this newly selected road.

The tracing need not extend from the tracing start point s1 to the tracing end point e1 along the road, and may be performed along only a segment of the road between the tracing start point s1 and the tracing end point e1.

As described above, in the present embodiment, the matching target roads are selected in accordance with the scale of the map displayed on the map screen, and the road used for setting the driving route is selected from among the matching target roads corresponding to the map scale. Therefore, when a plurality of roads are located closely adjacent one another, for example, it is possible to prevent a road different from the road intended by the driver from being set as the driving route. Accordingly, the intended road on the map screen can be accurately set as the driving route.

The flowchart of FIG. 4 will now be described. At Step S1, the touch mode is selected. As Step S2, the scale is read. At Step S3, the matching target road selection process is executed. At Step S4, the routine awaits tracing. If the tracing has been performed, the routine goes to Step S5. At Step S5, a road is selected. At Step S6, the driving route is displayed. At Step S7, whether or not a road has been traced is determined. If tracing has been performed, the routine goes to Step S8. If the tracing has not been performed, the procedure is completed. At Step S8, another road is selected. At Step S9, the driving route is displayed, and the routine ended.

In the above-described embodiment, the driving route is set by tracing with a finger along a road on the map screen. If the driver wants to change at least a part of the route selected in the route searching mode, and if the driver traces a predetermined section, a predetermined road can be selected and set as the driving route.

Further, in the above-described embodiment, a touch panel is used as the display unit 35, and a road on the map screen is designated by touch. Alternatively, a liquid crystal screen or the like can be used as the display unit 35, and the driving route can be set by the movement of a cursor along a road on the map screen.

The term “locus”, as used in the appended claims, includes a point, a series of points (connected as described above) and a line (tracing)specified by an operator on a map screen by touch, use of a cursor, etc.

Further, in the above-described embodiment, the driving route is set in the navigation device 14. Alternatively, the driving route can be set through the operation of a personal computer.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A route setting system comprising:
scale determination means for reading the scale of a map displayed on a map screen;
matching target road selection means for selecting, in accordance with the scale of the map, matching target roads which are candidates for use in setting a driving route;
specification determination means for determining whether or not a locus for the driving route has been specified on the map screen by an operator; and
road selection means for selecting, responsive to a locus for a driving route having been specified by the operator, one of the matching target roads nearest the specified locus as a road set for the driving route.

2. The route setting system according to claim 1,
wherein the matching target roads are classified in accordance with different scales of the map.

3. The route setting system according to claim 1,
wherein the specification determination means determines whether or not a road on the map screen has been traced to specify the locus of the driving route.

4. The route setting system according to claim 1,
wherein the specification determination means determines whether or not a point on the map screen has been specified as the locus for the driving route by touch of the map screen.

5. The route setting system according to claim 1 further comprising a mode switch, operable by the operator, for switching between a mode enabling the specifying of a locus of a driving route on a map screen by the operator and an automatic search mode.

6. A route setting method comprising:
reading scale of a map displayed on a map screen;
selecting, in accordance with the scale of the map, matching target roads which are candidates for setting a driving route;
determining whether or not a locus for a driving route has been specified on the map screen by an operator; and
selecting, responsive to a locus for a driving route having been specified by the operator, one of the matching target roads nearest the specified locus as a road set for the driving route.

7. A route setting method according to claim 6 further comprising operating a mode switch to select a mode enabling said specifying.

8. A route setting method according to claim 6 wherein the determining of whether or not a locus of a driving route has been specified is by determining of whether or not a road displayed on the map screen has been traced.

9. A route setting method according to claim 6 wherein the determining of whether or not a locus for a driving route has been specified is by determining whether or not a point on the map screen has been specified by touch of the map screen.

10. A computer-readable medium having encoded thereon program for executing a route setting method, the program causing a computer to function as scale determination means for reading the scale of a map displayed on a map screen, matching target road selection means for selecting, in accordance with the scale of the map, matching target roads which are candidates for setting a driving route, specification determination means for determining whether or not a locus for a driving route has been specified on the map screen by an operator, and road selection means for selecting, responsive to a locus having been specified by the operator, one of the matching target roads, nearest to the specified locus, as a road for setting the driving route.
